(19) United States
(12) Patent Application Publication
(10) Pub. No.: US 2003/0122383 A1
(43) Pub. Date: Jul. 3, 2003

(54) Add a seal

(76) Inventor: Sidney P. Gonzalez, Cottage Grove, OR (US)

Correspondence Address: SIDNEY P. GONZALEZ, P.O. BOX 753, COTTAGE GROVE, OR, 97424, US

(21) Appl. No.: 10/037,233

(22) Filed: Jan. 2, 2002

(51) Int. Cl. E05C 19/08

(52) U.S. Cl. 292/281

(57) ABSTRACT

This invention is a 2 piece metal device consisting of a specially shaped 2-inch body with a slotted tab and a 3/16 inch slotted thumbhead screw, to be installed on lid type metal boxes, cabinets, etc.

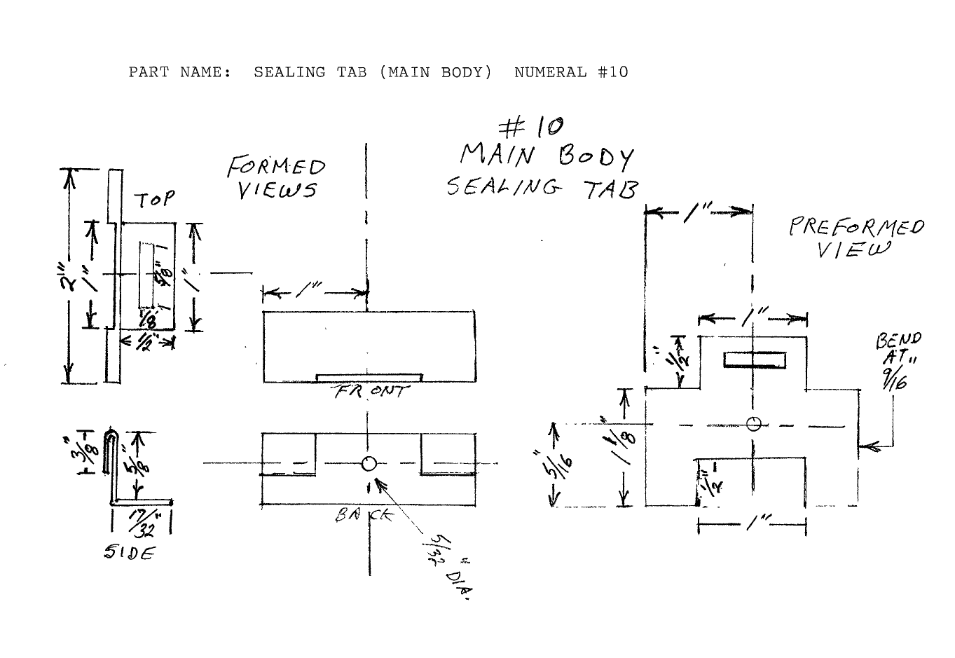

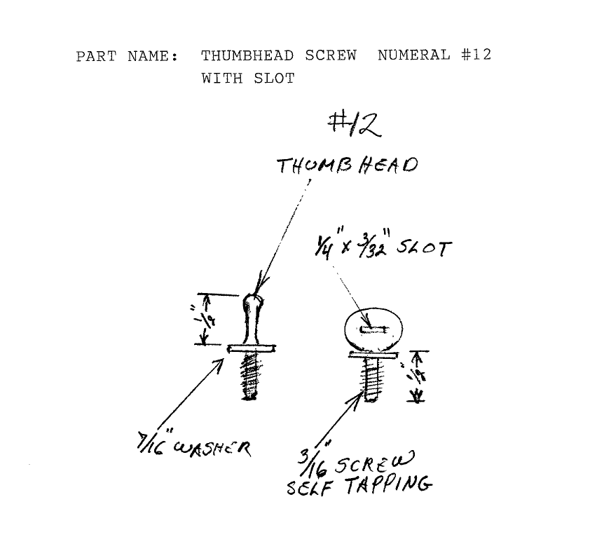

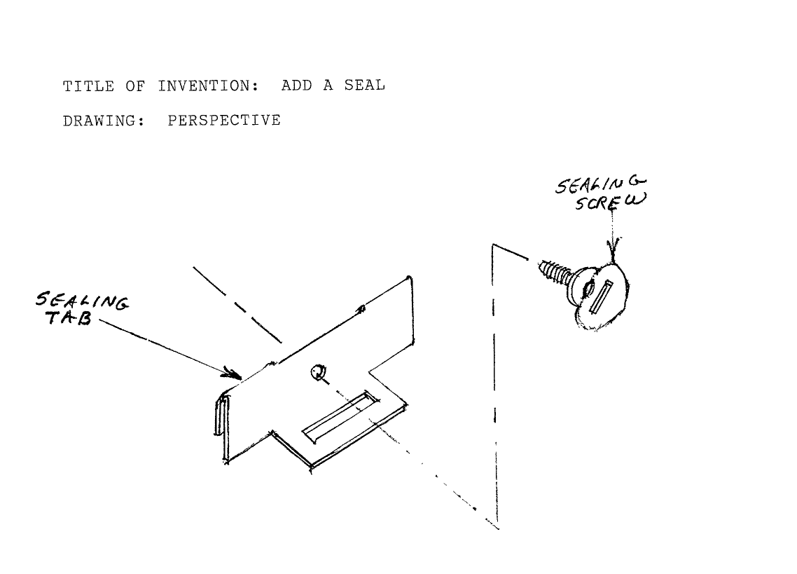

Once the installation is complete, the slots on the thumbhead screw and sealing tab are in alignment in order for a personal security seal to be applied through both slots. At this point the installation can be checked at any time for possible breach of security and pursued accordingly. The shape and design of the main body and thumbhead screw allow installation on most or all metal utility boxes and similar containers or cabinets. A variety of wire and cable type security seals available on the market today may be applied to the installation for the additional security that it was designed for.

### B. CROSS-REFERENCE TO RELATED APPLICATIONS

1. Security Item for Metal Electric Boxes (Any Size)

a. Electric meter socket boxes

b. Electric component boxes

c. Metal Boxes (General Utility Interior or Exterior)

2. T.V. Cable (Metal Boxes) (Any Size)

a. Service termination boxes

b. Junction boxes

c. Boxes requiring security (interior or exterior)

3. Telephone (Metal Boxes) (Any Size) (Interior or Exterior)

a. Termination boxes

4. General Public (Metal Boxes) (Any Size) (Interior or Exterior)

a. Electric breaker boxes

b. Key boxes

c. Computer cabinets

d. Various security boxes

### C. STATEMENT REGARDING FEDERALLY SPONSORED RESEARCH AND DEVELOPMENT

Not Applicable

### D. REFERENCE TO A MICROFICHE APPENDIX

Not applicable

### E. BACKGROUND OF THE INVENTION

This invention relates to security sealing tabs on electric meter socket boxes. As part of a requirement by electric utility companies, their customers must provide an approved sealable location on the customer's electric meter socket box in order for the utility company to apply its security seal once the electric meter is set.

This sealable location must remain valid and available during the entire time an electric meter remains in the electric meter socket box.

This same requirement applies to the distribution box access lid when it is part of the overall electric meter box installation.

Manufacturers of electric meter socket boxes and related electric components, i.e. current transformer boxes, have satisfied the required sealable location as part of the design of their products.

Because of accidents, tamperings, theft of service, criminal mischief, wear, weather and the like, this sealable location becomes compromised or invalid and no longer offers the security required by the utility company.

In this situation the utility customer is often required to fix, replace or in someway provide another approved and valid sealable tab or location.

The entire responsibility rests on the utility customer and/or owner of the electrical metering installation or person or company that caused such damage as to lose the security sealability.

This required and approved sealable location invariably amounts to 1% or less material mass of the entire meter installation, but never the less is a necessary security item. A few of the electric meter socket box manufacturers make a valid and approved sealable replacement tab “for their own products only.”

Utility companies have been dealing with this situation for years and are successful with replacements for some meter socket box sealing tabs, but not all, i.e. old boxes.

This small but necessary item can cause costly meter socket box replacement, electrician fees and loss of electricity while replacement is completed.

This invention provides a replacement security-sealing tab for any make and model, old or existing electric meter socket box.

### F. SUMMARY

This invention consists of 2 physical pieces. One is the main body and the other is an accompanying screw. Both pieces are specifically designed to work together to replace the required security tab that is lost or has become ineffective for whatever reason.

OBJECT AND ADVANTAGES: The object of this invention is not only to replace the required security seal tab, but also to install additional security seal tabs on the same electric meter base installation for increased security monitoring, if desired. If an electric company suspects a customer of tampering, in some way, with their electric meter or service, installing additional sealing tabs would offer additional security monitoring of the installation as well as a way to inform the suspect that the electric meter installation, service and account have been selected for increased monitoring purposes. This in itself may help to deter the idea of energy diversion or tampering with the installation. Because of the shape and design of this 2-piece invention, it may be applied to virtually any metal type box with a lid that someone would like to monitor for security reasons. Not only can this security sealing tab invention be applied easily, but with little to no disruption of service while installation is done. It can be applied to electric, telephone and television cable boxes alike and will be available to the public and private entities without compromise of security to each other.

### H. LIST OF REFERENCE NUMERALS

10. Main body (sealing tab)

12. Thumbhead sealing screw with slot

### I. DESCRIPTION

1. Main body—This piece is a 2 inch wide by ⅝ inch high 20 gauge galvanized metal body, with a 1 inch slotted tab protruding to the front of this main body and 2-½ inch grip tabs bent down on the back of the main body at each end. It also has a 5/32-inch hole in the center of the body.

2. Sealing screw—This is an accompanying 3/16-inch by ½ inch galvanized self-tapping screw with a slotted thumb head and a 7/16 inch flange or washer between the head and the threads of the screw. This screw fits together with the main body. The slot in the thumb head is ¼ by 3/32 inches.

### J. OPERATION

Main embodiment—The following explains how the main body of the invention works. First the main body, or seal tab as it is called, must be put in place along the edge of the metal box and the lid of the box closed down over the sealing tab. Then a single ¼ inch hole is drilled through the closed lid and box edge, but not through the predrilled sealing-tab. This hole may be drilled at any convenient or strategic location on the box and lid as long as it will relate and align with the hole on the sealing tab. Then the hole in the body of the sealing tab should be aligned with the hole drilled in the lid and edge of the box. With these holes aligned, the body of the sealing tab will be in place over the inside edge of the box. Once the lid is closed, three holes are aligned, the hole on the edge of the lid, the sealing tab and the inside edge of the box. With the lid closed down on the box, the sealing tab body is covered and only the sealing tab slot is exposed from under the edge of the lid. At this time the slotted thumhead sealing screw is placed through the drilled holes. This leaves the slot on the sealing screw aligned with the slot on the sealing tab. At this point the installation of the main body with thumbhead screw is complete. The utility company now has another approved sealable and valid security location to apply its security seal on the electric meter box installation.

### K. DESCRIPTION AND OPERATION

Alternative embodiments—There are other sealing tab type pieces that are available, similar in shape but not size and have no holes drilled through them. These pieces are generally made by a few local people throughout the country to satisfy a local and immediate need. The pieces that are produced vary in size and shape and are limited in use to specific and particular box applications. Other utilities such as telephone, cable and the like, are unable to make use of them,

### L. CONCLUSION, RAMIFICATIONS, AND SCOPE

CONCLUSIONS: In the presentation of this invention, reference has been made for application primarily on utility company type metal boxes. For those in the electric utility business whose work involves dealing with electric utility meter boxes, the idea of this invention may seem to apply only to what is called ringless type meter installations in contrast to ring type installations. However, for those utility personnel who have the duty of investigating meter bases on accounts where the security location has been compromised or offers dubious security for whatever reason, this invention can be of value for both ringless and ring type installations alike.

RAMIFICATIONS: The greater advantage of this invention is that it will fit any metal box type installation. Because of the many manufacturers of utility boxes, there are a variety of boxes that utilities carry replacement parts for in their inventory.

This invention would reduce that inventory considerably since this fits all boxes.

SCOPE: Because of the shape and size of this invention, it can be used on any metal box type installation where security monitoring is desired. To name a few applications: electric, telephone, cable, television, tool boxes, criminal evidence, key boxes, computer components, and many, many other applications that may be thought of.

1. This invention provides a 2-piece device to be applied to a lid type metal box providing a location for a personal seal to be attached for security monitoring purposes of said box.
A. A 2 inch wide 20 gauge galvanized metal body that is shaped to slip over the inside edge of a metal box leaving a 1 inch slotted sealing tab exposed to the box exterior and paralleling the lid when the lid is in the closed position.
B. A metal 3/16-inch self-tapping, slotted thumbed screw.
C. A ¼ inch hole is pre-drilled at the proper location through the edges of the lid and inside edge of the metal box with alignment to allow the 3/16 slotted thumbed screw to be inserted through the edge of the lid, the 2 inch wide metal body and the inside edge of the box.
